(19) United States
(12) Patent Application Publication
(10) Pub. No.: US 2015/0013337 A1
(43) Pub. Date: Jan. 15, 2015

(54) Thermal Transpiration Generator System

(71) Applicants: Mark Eugene Nutter, Newark, OH (US); Ronald Leo Wollenberg, Meadow Vista, CA (US)

(72) Inventors: Mark Eugene Nutter, Newark, OH (US); Ronald Leo Wollenberg, Meadow Vista, CA (US)

(73) Assignee: Engineering Manufacturing Contractors, LLC, Newark, OH (US)

(21) Appl. No.: 14/288,253

(22) Filed: May 27, 2014

Related U.S. Application Data
(60) Provisional application No. 61/827,342, filed on May 24, 2013.

(51) Int. Cl. F03G 6/06

(52) U.S. Cl. CPC F03G 6/06
USPC 60/641.15

(57) ABSTRACT

A thermal transpiration generator system includes a parabolic dish, a secondary reflector receiving solar energy from the parabolic dish, and a carrier tube directing solar energy from the secondary reflector to a thermal transpiration generator. The thermal transpiration generator includes a sealed vacuum container, a horizontally disposed rotatable shaft within the sealed vacuum container, bearings supporting the rotatable shaft, a first set of vanes secured to the rotatable shaft for rotation therewith, a second set of vanes secured to the rotatable shaft for rotation therewith, a high rpm flywheel secured to the shaft between the first and second sets of vanes, an electric generator operatively coupled to the rotatable shaft to be driven by rotation of the rotatable shaft, and a solar energy distribution system for receiving solar energy from the carrier tube and directing light to each of the first and second sets of vanes.

### CROSS-REFERENCE TO RELATED APPLICATIONS

This application claims the priority benefit of U.S. Provisional Patent Application No. 61/827,342 filed on May 24, 2013, the disclosure of which is expressly incorporated herein in its entirety by reference.

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to power generation systems and, more particularly, to power generation systems using solar energy to generate electricity.

### BACKGROUND OF THE INVENTION

Currently, electric generators typically require fuels that render them expensive to operate. Some gasoline and steam powered generators are also noisy and can generate undesirable exhaust gases. Additionally, the generators that require gasoline or other carbon-based fuels have undesirable time restrictions and output limitations. Batteries can be used as back-ups but the electric generators still only operate under a limited time due to battery life, and usually are limited in overall capacity. As a result alternative energy powered generators such as solar powered generators have been developed. However, current solar powered generators require an extensive amount of area for solar panels to obtain desired power output levels and are quite expensive.

Thermal transpiration generators or radiometers (aka solar engines or Crookes Radiometers) are known. Such generators exploit the physical phenomena known as thermal transpiration wherein a thermal gradient at the edge of a rotating vane having opposed light reflecting and light absorbing surfaces causes a rarefied or low density gas to slip across the gradient from the cold side to the hot side thereby effecting motion of the vane. While these generators have shown that they are capable of generating some electricity in a laboratory environment, they have yet to produce desired levels of electricity with compact systems.

Accordingly, there is a need for improved thermal transpiration generator systems and methods.

### SUMMARY OF THE INVENTION

Disclosed are thermal transpiration generator systems and methods which address one or more issues of the related art. Disclosed is a thermal transpiration generator comprising, in combination, a sealed container, a rotatable shaft horizontally disposed within the sealed container, bearings supporting the rotatable shaft within the sealed container, a first set of at least two vanes secured to the rotatable shaft for rotation therewith, a second set of at least two vanes secured to the rotatable shaft for rotation therewith and spaced apart from the first set of at least two vanes along the length of the rotatable shaft, and an electric generator operatively coupled to the rotatable shaft to be driven by rotation of the rotatable shaft, and a solar energy distribution system for directing light to each of the first and second sets of at least two vanes. Each of the vanes has a light reflecting side and an opposite light absorbing side.

Also disclosed is a thermal transpiration generator comprising, in combination, a sealed container, a rotatable shaft disposed within the sealed container, bearings supporting the rotatable shaft within the sealed container, a first set of at least two vanes secured to the rotatable shaft for rotation therewith, a second set of at least two vanes secured to the rotatable shaft for rotation therewith and spaced apart from the first set of at least two vanes along the length of the rotatable shaft, a high RPM flywheel secured to the rotatable shaft for rotation therewith, an electric generator operatively coupled to the rotatable shaft to be driven by rotation of the rotatable shaft, and a solar energy distribution system for directing light to each of the first and second sets of at least two vanes. Each of the vanes has a light reflecting side and an opposite light absorbing side.

Also disclosed is a thermal transpiration generator system comprising, in combination, a parabolic dish, a secondary reflector receiving energy from the parabolic dish, a carrier tube receiving solar energy from the secondary reflector, and thermal transpiration generator receiving solar energy from the carrier tube. The thermal transpiration generator includes a sealed container, a rotatable shaft disposed within the sealed container, bearings supporting the rotatable shaft within the sealed container, a first set of at least two vanes secured to the rotatable shaft for rotation therewith, a second set of at least two vanes secured to the rotatable shaft for rotation therewith and spaced apart from the first set of at least two vanes along the length of the rotatable shaft, an electric generator operatively coupled to the rotatable shaft to be driven by rotation of the rotatable shaft, and a solar energy distribution system receiving solar energy from the carrier tube and directing light to each of the first and second sets of at least two vanes. Each of the vanes has a light reflecting side and an opposite light absorbing side.

From the foregoing disclosure and the following more detailed description of various preferred embodiments it will be apparent to those skilled in the art that the present invention provides a significant advance in the technology and art of thermal transpiration generator systems and methods. Particularly significant in this regard is the potential the invention affords for providing relatively compact and versatile thermal transpiration generator systems and methods which greatly improve electrical output from relatively small sized systems. Additional features and advantages of various preferred embodiments will be better understood in view of the detailed description provided below.

### BRIEF DESCRIPTION OF THE DRAWINGS

These and further features of the present invention will be apparent with reference to the following description and drawings.

FIG. 1 is a front perspective view of a thermal transpiration generator system according to a first embodiment of the present invention.

FIG. 2 is a rear elevational view of a thermal transpiration generator of the thermal transpiration generator system of FIG. 1.

FIG. 3 is a top plan view of the thermal transpiration generator of FIGS. 1 and 2.

FIG. 4 is a left end elevational view of the thermal transpiration generator of FIGS. 1 to 3.

FIG. 5 is a diagrammatic view of the thermal transpiration generator of FIGS. 1 to 4.

FIG. 6 is a perspective view of an alternative configuration for a set of vanes for the thermal transpiration generator of FIGS. 1 to 5.

FIG. 7 is an end view of the alternative set of vanes of FIG. 6.

FIG. 8 is a top plan view of an alternative configuration for a solar energy distribution assembly of the thermal transpiration generator of FIGS. 1 to 5.

FIG. 9 is a top plan view of another alternative configuration for a solar energy distribution assembly of the thermal transpiration generator of FIGS. 1 to 5.

FIG. 10 is a side elevational view of the alternative configuration for a solar energy distribution assembly of FIG. 9.

FIG. 11 is an end view of the alternative configuration for a solar energy distribution assembly of FIGS. 9 and 10.

FIG. 12 is a perspective view of a thermal transpiration generator system according to a second embodiment of the present invention.

FIG. 13 is a perspective view of a thermal transpiration generator system according to a third embodiment of the present invention.

FIG. 14 is a perspective view of a thermal transpiration generator system according to a fourth embodiment of the present invention.

FIG. 15 is a perspective view of a thermal transpiration generator system according to a fifth embodiment of the present invention.

FIG. 16 is a perspective view of a thermal transpiration generator according to a sixth embodiment of the present invention.

FIG. 17 is an enlarged fragmented perspective view of a portion of the thermal transpiration generator of FIG. 16.

FIG. 18 is an enlarged fragmented perspective view of another portion of the thermal transpiration generator of FIGS. 16 and 17.

FIG. 19 is an enlarged fragmented perspective view similar to FIG. 18 but showing an alternative location for the electric generator.

FIG. 20 is a perspective view of a thermal transpiration generator according to a seventh embodiment of the present invention.

FIG. 21 a perspective view of a thermal transpiration generator according to an eighth embodiment of the present invention.

FIG. 22 is perspective view of a thermal transpiration generator according to a ninth embodiment of the present invention

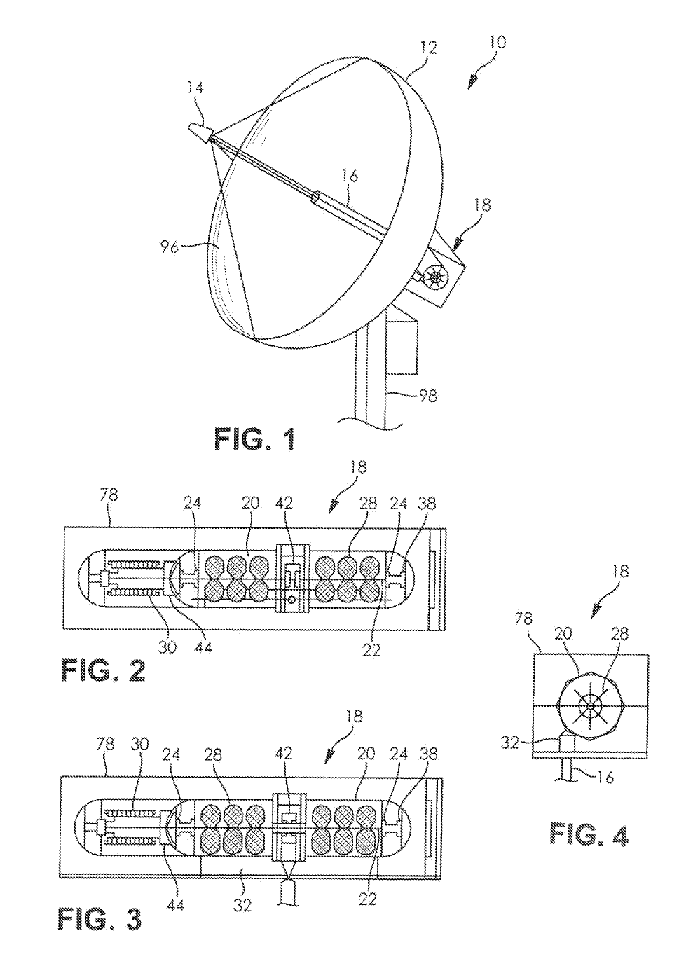

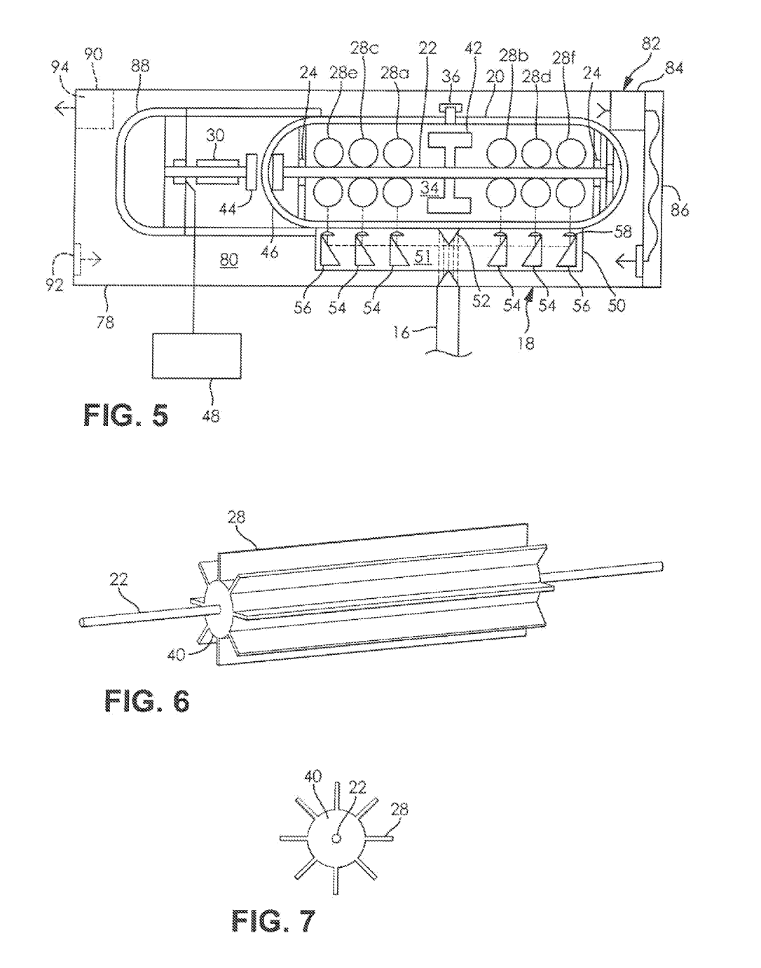

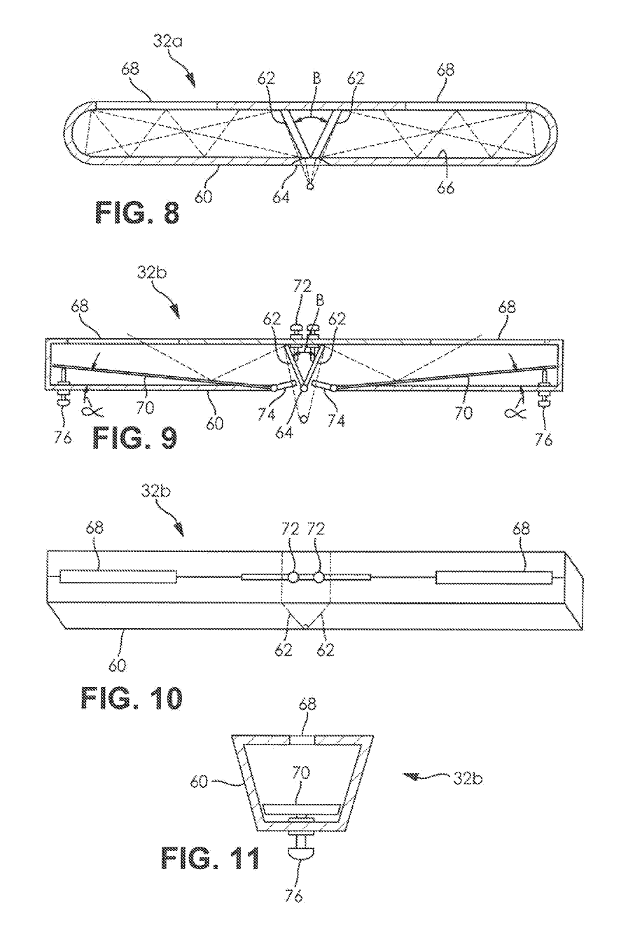

It should be understood that the appended drawings are not necessarily to scale, presenting a somewhat simplified representation of various preferred features illustrative of the basic principles of the invention. The specific design features of the thermal transpiration generator systems as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the covers for portable electronic devices illustrated in the drawings. In general, up or upward generally refers to an upward direction within the plane of the paper in FIG. 1 and down or downward generally refers to a downward direction within the plane of the paper in FIG. 1. Also in general, front or forward generally refers to a direction toward the right within the plane of the paper in FIG. 1 and rear or rearward generally refers to a direction toward the left within the plane of the paper in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the thermal transpiration systems disclosed herein. The following detailed discussion of various alternative and preferred embodiments will illustrate the general principles of the invention. However, other embodiments suitable for other applications will be apparent to those skilled in the art given the benefit of this disclosure.

Referring now to the drawings, FIGS. 1 to 5 show a thermal transpiration generator system 10 according to a first embodiment of the present invention. The illustrated thermal transpiration generator system 10 includes a parabolic dish 12, a secondary reflector 14 receiving solar energy from the parabolic dish 12, and a carrier tube 16 directing solar energy from the parabolic dish 12 to a thermal transpiration device or generator 18. The illustrated thermal transpiration device or generator 18 includes a sealed vacuum container 20, a rotatable shaft 22 within the sealed vacuum container 20, bearings 24 rotatably supporting the rotatable shaft 22, a first set of vanes 28a secured to the rotatable shaft 22 for rotation therewith, a second set of vanes 28b, secured to the rotatable shaft 22 for rotation therewith, an alternator or electric generator 30 operatively coupled to the rotatable shaft 22 to be driven by rotation of the rotatable shaft 22, and a solar energy distribution system 32 for receiving solar energy from the carrier tube 16 and directing light to each of the first and second sets of vanes 28a, 28b, to rotate the vanes 28 and shaft 22 to drive the electric generator 30.

Thermal Transpiration is a physical process of converting rarefied gas flow into electrical energy. The illustrated thermal transpiration generator system utilizes the sun's energy to turn the vanes 28, the shaft 22, and the alternator or electric generator 30 to generate AC or DC power. The illustrated thermal transpiration generator system 10 can be used to power home residences, charge batteries of all types, and power various commercial facilities. The illustrated thermal transpiration generator system's size and shape, vane design, generator size and output, and added features to enhance the product's performance can be varied to deliver the necessary power requirements to fulfill various electrical markets as described in more detail hereinafter.

The illustrated sealed vacuum container 20 is generally cylindrical-shaped having rounded ends and his horizontally disposed. It is noted that the vacuum container 20 can alternatively have any other suitable shape and/or orientation. The vacuum container 20 forms a sealed hollow interior space 34 suitable for holding the rotatable shaft 22 and other components as described in more detail hereinafter. The vacuum container 20 is configured to hold an inert gas such as, for example, helium, argon, or the like at a vacuum or near vacuum pressure level. The sealed vacuum container 20 is preferably filled with a suitable inert gas (volume and type) to maximize turning performance of the vanes 28. The vacuum container 20 can be formed of any suitable material such as for example, Pyrex, stainless steel, aluminum alloy, or the like. If the material of the vacuum container 20 does not permit passage of the desired solar energy therethrough to the vanes 28, such as when metallic, the vacuum container 20 is provided with adequate windows for passage of the solar energy therethrough to the vanes 28. The illustrated vacuum container 20 is hermetically sealed and has a single port 36 for inert gas insertion to fill the vacuum container 20 to achieve the optimum vacuum level for optimal system performance. Once filled and hermetically sealed, the desired vacuum level should be maintained in the sealed vacuum container 20 for the life of the system.

The illustrated rotatable shaft 22 is rotatably supported within the sealed vacuum container 20 for rotation on its longitudinal axis and is horizontally disposed such that it is generally coaxial with the cylindrical-shaped vacuum container 20. The illustrated shaft 22 has a length that extends nearly the entire longitudinal length of the interior cavity 34 of the vacuum container 20 but any other suitable length can alternatively be utilized. The illustrated shaft 22 is configured for high speed rotation of about 10,000 rpm to 100,000 rpm but any other suitable configuration can alternatively be utilized. The illustrated shaft 22 comprises stainless steel but any other suitable material can alternatively be utilized.

The illustrated bearings 24 rotatably support the rotatable shaft 22 within the vacuum container 20. The illustrated shaft 22 is supported in the vertical direction by a pair of passive frictionless magnet bearings 24 The illustrated passive magnetic bearings 24 are spaced apart along the length of the shaft 22 near the ends of the shaft 22 and outside the vane sets 28a, 28b. It is noted that any other suitable type of bearings 24 can alternatively be utilized to support the shaft 22 such as, for example, active frictionless magnetic bearings or the like. However, it is noted that the passive magnetic bearings 24 are preferred because an electrical feed through in the vacuum container wall is not required to provide power to the bearings 24. As a result, the illustrated vacuum container 20 can be hermetically sealed. A first end of the illustrated shaft 22 is also provided with a jeweled bearing 38 configured to prevent wobble of the shaft 22. It is noted that alternatively, any other suitable configuration to prevent wobble of the shaft 22 can alternatively be utilized.

The illustrated sets of vanes 28a, 28b, 28c, 28d, 28e, 28f are secured to the rotatable shaft 22 for rotation therewith and preventing relative motion therebetween. The vanes 28 can be secured to the shaft 22 in any suitable manner. The position of the vanes 28 relative to the shaft 22 is preferably adjustable so that the position of the vanes 28 can be optimized depending on the energy path and energy delivery system along with the vane energy absorption and thrust efficiencies. The illustrated shaft 22 has six sets of vanes 28a, 28b, 28c, 28d, 28e, 28f longitudinally spaced apart along the length of the shaft 22 but any other suitable number of sets of vanes 28a, 28b, 28c, 28d, 28e, 28f can alternatively be utilized. The illustrated sets of vanes 28a, 28b, 28c, 28d, 28e, 28f are divided equally on both sides of a flywheel 42 (described in more detail hereinafter) but it is noted that the sets of vane 28a, 28b, 28c, 28d, 28e, 28f can alternatively be distributed in any other suitable configuration. Each of the illustrated sets of vanes 28a, 28b, 28c, 28d, 28e, 28f includes eight vanes 28 that radially extend from the shaft 22 and are equally spaced apart about the circumference of the shaft 22. It is noted that the sets of vanes 28a, 28b, 28c, 28d, 28e, 28f can each alternatively have any other suitable quantity of vanes 28.

Each of the illustrated vanes 28 is generally oval shaped but can alternatively have any other suitable shape such as, for example, rectangular, circular, triangular, trapezoidal, or the like. The illustrated vanes 28 have flat surfaces but the surfaces can alternatively be convex or concave. The vanes 28 can comprise any suitable material. The illustrated vanes 28 have opposed heat reflecting and heat absorbing sides. The heat reflecting and heat absorbing sides can be formed in any suitable manner such as, for example, white and black paint respectively. The heat absorbing sides are the targets of the solar energy distributed to the vanes 28 by the solar energy distribution assembly 32 as described in more detail hereinafter. The vanes 28 are shaped, sized, and formed a suitable material to optimally receive focused light that creates a pressure difference on each side of the vane 28 (involving higher pressure from faster moving escaped inert gas molecules on the dark absorbing side versus slower moving molecules from the light reflective side) allowing the internal inert gas and the subsequent energy to push the vanes 28.

FIGS. 6 and 7 illustrate an alternative configuration for the vanes 28 wherein the vane set 28a, 28b, 28c, 28d, 28e, 28f is configured in a water wheel manner. This alternative configuration for the vanes 28 illustrates that the vanes 28 can alternatively have other suitable configurations. Each illustrated vane 28 is relatively long so that fewer vane sets are required and as few as one set of vanes 28a, 28b, 28c, 28d, 28e, 28f is required if the vanes 28 have a length that extends substantially the entire interior length of the vacuum container 20. Configured in this manner the vanes 28 each have a longitudinally extending length that is substantially greater than its radially extending width. The illustrated vanes 28 are secured to a hub 40 which is in turn secured to the shaft 22 but the vanes 28 can alternatively be secured in any other suitable manner.

The illustrated thermal transpiration generator 18 also includes a flywheel 42 secured to the shaft 22 for rotation therewith in order to store mechanical momentive energy. The stored kinetic energy is helpful when the sun is behind a cloud and/or for an initial period of time after the sun sets in the evening. The mass of the illustrated flywheel 42 is designed to travel outward (increase energy) toward the container wall based on the rpm of the shaft 22. The illustrated flywheel 42 is a lightweight, high rpm flywheel configured for rotation of about 10,000 rpm to about 100,000 rpm. The flywheel 42 can comprise carbon nanotubes such as, for example, graphene or the like that withstands the high rpm operation without breaking apart but can alternatively comprise any other suitable material that withstands the high rpm operation. The flywheel 42 can be provided with a housing if desired and can also be provided with a liquid filled housing if desired. The illustrated flywheel 42 is centrally located along the shaft 22 and centrally located among the sets of vanes 28a, 28b, 28c, 28d, 28e, 28f, with three sets of vanes 28a, 28b, 28c, 28d, 28e, 28f on each side of the flywheel 42. It is noted that the flywheel 42 can alternatively be located at any other suitable location such as, for example, outside the vacuum container 20 (as shown in FIG. 14). The flywheel 42 is sized and shaped for mechanical performance to optimize performance of the overall system. It is noted that the flywheel 42 can alternatively have any other suitable configuration.

The illustrated electric alternator or generator 30 is operatively coupled to the rotatable shaft 22 to be driven by rotation of the rotatable shaft 22 to produce electric current. The illustrated electric generator 30 is a low torque, high rpm generator for operation at rotational speeds of about 10,000 rpm to about 100,000 rpm but any other suitable type of electric generator can alternatively be utilized. The illustrated electric generator 30 is located outside the sealed vacuum container 20 and operatively coupled to the shaft 22 via a magnetic coupler 44 operating through the wall 46 of the sealed vacuum container 20. It is noted that the electric generator 30 is preferably located outside the vacuum container 20 because an electrical feed through in the vacuum container wall 46 is not required and that the magnetic coupler 44 is preferred because a shaft feed through in the vacuum container wall 46 is not required. The magnetically coupled drive 44 is engaged and disengaged by a control system 48 based on the accomplished vane/flywheel drive torque and revolutions achieved with the system. The shaft's rotational speed is monitored and the magnetic engagement is controlled by the control system 48. As a result, the illustrated sealed vacuum container 20 can be hermetically sealed. Thus creating an environment that will not require maintenance to maintain the ideal internal atmospheric condition with regard to optimum amount of inert gas and vacuum requirements to optimize performance of the thermal transpiration generator system 10. The electric alternator or generator 30 can be of any suitable type and more than one electric generator 30 can be utilized such as, for example, there can be an electric generator 30 at each end of the shaft 22 or along the length of the shaft 22.

The illustrated solar energy distribution assembly 32 is configured for receiving solar energy from the carrier tube 16 and directing light to each of the sets of vanes 28a, 28b, 28c, 28d, 28e, 28f. The illustrated solar energy distribution assembly 32 includes a housing forming 50 a hollow interior cavity 51 and secured along the side of the vacuum container 20. The carrier tube 16 directs solar energy centrally into a side of the housing 50 and perpendicular to the shaft 22 to a prism shaped mirror 52 which within the cavity 51 that directs the solar energy in opposed first and second directions toward ends of the housing 50 and parallel to the shaft 50. In each direction, the solar energy passes through beam splitting prisms 54 which reflect a portion of the solar energy toward the adjacent inner vane sets 28a, 28b, 28c, 28d, 28e, 28f and transmit a portion along the same path parallel to the shaft 22. A final reflective prism 56 reflects all the remaining solar energy toward the adjacent outer vane set. Fresnel lenses 58 are provided which are configured to focus the solar energy on the absorbing side of the adjacent vane 28. The illustrated solar energy distribution assembly 32 evenly distributes the solar energy to the sets of vanes 28a, 28b, 28c, 28d, 28e, 28f. The solar energy is disbursed to the absorbing sides of the vanes 28 where energy is absorbed to create a rapidly accelerated atomic energy thrust away from the dark side to rotate the vanes 28 and the shaft 22 connected thereto to operate the electric generator 30. It is noted that the solar energy distribution assembly 32 can alternatively have any other suitable configuration.

FIG. 8 illustrates an alternative solar energy distribution assembly 32a including a tube 60, circular in cross section, with mirrors 62 at a controlled inlet opening or iris 64, a reflective inner surface 66 of the tube 60, and outlet openings or slits 68 adjacent the sets of vanes 28a, 28b, 28c, 28d, 28e, 28f. This alternative solar energy distribution assembly 32a illustrates that the energy distribution assembly 32 can alternatively have other suitable configurations. The inlet 64 and the mirrors 62 are centrally located within the tube 60 so that incoming solar energy is reflected in opposite directions toward the ends of the tube 60. An angle B formed between the reflective surfaces of the mirrors 62 is determined to reflect solar energy the entire distance of the tube 60 and distribute light to all surfaces of the tube 60. The iris 64 can be motorized to automatically open and close to take into account variability of solar intensity due to atmospheric conditions. The inner surface 66 of the tube 60 is mirrored or highly polished metal such as, for example, aluminum or the like. The mirrored inner surface 66 of the tube is configured to maximize scattering of solar energy within the tube 60 for even distribution to the vanes 28. The outlet slits 68 are located adjacent the vanes 28 to allow concentrated solar energy out of the tube 60 to the vanes 28.

FIGS. 9 to 11 illustrate another alternative solar energy distribution assembly 32b including solar energy inlet 64, a plurality of adjustable mirrors 62, 70, and outlet openings or slits 68 adjacent the sets of vane 28a, 28b, 28c, 28d, 28e, 28f. This alternative solar energy distribution assembly 32b also illustrates that the solar energy distribution assembly 32 can alternatively have other suitable configurations. The inlet 64 and the first mirrors 62 are centrally located within the tube 60 so that incoming solar energy is reflected in opposite directions toward second mirrors 70 near the ends of the tube 60 opposite the outlet openings 68. An angle B formed between the reflective surfaces of the first mirrors 62 is determined to reflect solar energy the entire reflective surfaces of the second mirrors 70. The first mirrors 62 are hinged together at one end and are provided with thumb screws 72 for manual adjustment of angle B. The inlet opening 64 has motorized hinged doors 74 that automatically open and close to take into account variability of solar intensity due to atmospheric conditions. An angle A formed between reflective surfaces of the second mirrors 70 and the tube 60 are determined to reflect solar energy to the outlet slits 68 to the vanes 28. The second mirrors 70 are provided with thumb screws 76 for manual adjustment of angle A. The outlet slits 68 are located adjacent the vanes 28 to allow concentrated solar energy out of the tube 60 to the vanes 28.

The illustrated thermal transpiration generator 18 also includes an outer housing or cooling jacket 78 that forms a sealed interior space 80 for the sealed container 20, the electric generator 30, and the solar energy distribution assembly 32. The illustrated cooling jacket 78 is provided with a cooling system 82 in the form of a pump 84 and a radiator 86 so that a cooling liquid such as, for example, water, refrigerant, or the like can be circulated from within the interior space 80 of the cooling jacket 78 to the radiator 86 and back into the cooling jacket 78 to keep the thermal transpiration generator 18 at or near ambient temperature. The illustrated electric generator 30 is provided with a sealed housing 88 secured to the sealed vacuum container 20 to prevent direct contact of the cooling liquid with the electric generator 30. The sealed housing 88 about the electric generator 30 is preferably hermetically sealed. It is noted that the radiator 86 can be replaced so that the cooling liquid is pumped to provide heat energy elsewhere such as, for example, a home hot water heater, swimming pool, or the like. It is also noted that the pump 84 and the radiator 86 can alternatively be replaced with a fan 90 and air inlets and outlets 92, 94 to air cool the thermal transpiration generator 18. It is further noted that the cooling system 82 can have any other suitable configuration or the cooling system 82 can be eliminated if desired.

The illustrated parabolic dish 12 is configured to receive solar energy from the sun at a parabolic shaped reflective surface 96 and reflect it to the secondary reflector 14 secured thereto in a known manner. The parabolic dish 12 preferably has a tracking mechanism that tracks the parabolic dish 12 with the sun so that the parabolic dish 12 is always at an optimum position to receive the solar energy. The parabolic dish 12 can alternatively be configured in any other suitable manner. The secondary reflector 14 receives the solar energy from the parabolic dish 12 and reflects it back in a collimated beam of light toward the carrier tube 16. The secondary reflector 14 can be of any suitable type. The carrier tube 16 receives solar energy from the secondary reflector 14 and carries it to the solar energy distribution assembly 32 of the thermal transpiration device or generator 18. The illustrated carrier tube 16 is located at the center of the parabolic dish 12 and extends through the parabolic dish 12 to the thermal transpiration device or generator 18 which is mounted at the back of the parabolic dish 12 so that it travels with the parabolic dish 12 as the parabolic dish 12 tracks the sun. The carrier tube 16 can be of any suitable type and can alternatively be configured in any other suitable manner. The thermal transpiration generator 18 can alternatively be located in any other suitable location.

The control system 48 is located outside the cooling jacket 78 and can be mounted separately such as, for example, mounted to the support stand of the parabolic dish 12. The control system 48 is configured to maintain the most efficient electrical system for powering a number of different auxiliary entities such as, for example, a home, garage, a battery charging station, a cell phone tower site, or the like. The control system 48 is preferably expandable to allow for such auxiliary systems to be included and preferably has an Internet hook-up so that the software of the control system can be remotely updated as desired. If the system is supplying power to a home, it can include necessary hardware for hook-up to a utility company's power feed to supplement the home power or return power to the utility company when excess power is available. DC to AC inverters may be included to convert DC power from a storage battery charged by the system to AC power for home use.

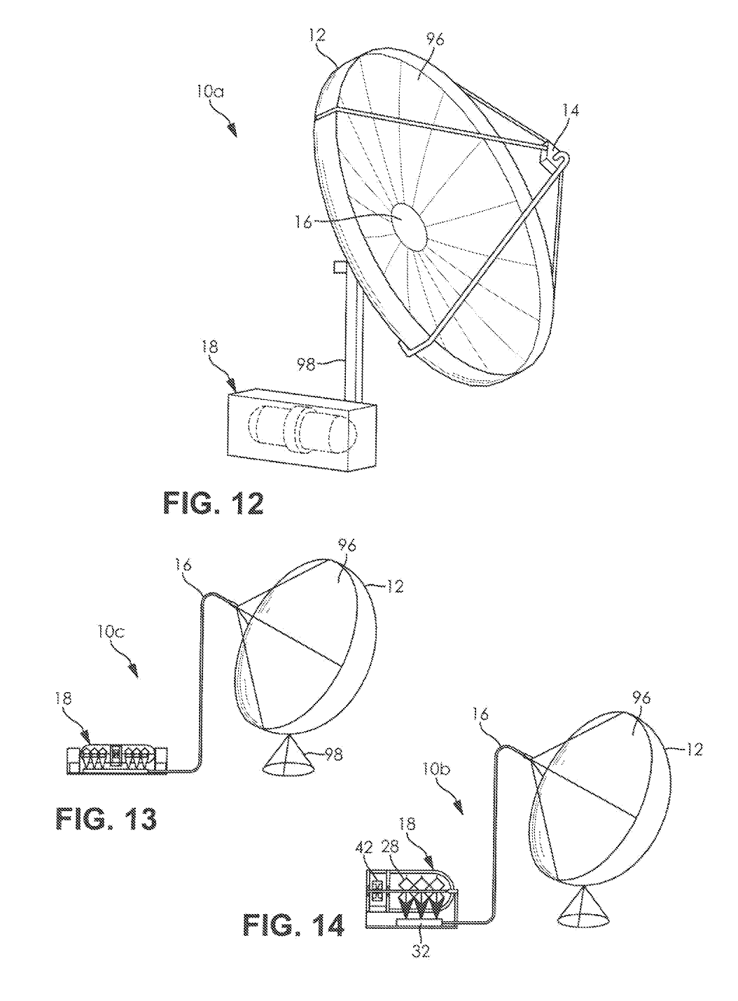

FIG. 12 shows a thermal transpiration generator system 10a according to a second embodiment of the present invention. This thermal transpiration generator system 10a is substantially the same as the thermal transpiration generator system 10 described above according to the first embodiment of the present invention except that the thermal transpiration device or generator 18 is in a different location. The illustrated transpiration device or generator 18 is located at a base 98 of the parabolic dish 12. This second embodiment of the thermal transpiration generator system 10a illustrates that the thermal transpiration generator 18 can alternatively be located in any other suitable location.

FIG. 13 shows a thermal transpiration generator system 10b according to a third embodiment of the present invention. This thermal transpiration generator system 10b is substantially the same as the thermal transpiration generator system 10a described above according to the second embodiment of the present invention except that the secondary reflector 14 has been eliminated and the parabolic dish 12 reflects the solar energy directly into the carrier tube 16 which has an inlet located at the focal point of the parabolic dish 12 in place of the secondary reflector 14. The illustrated transpiration device or generator 18 is located on the ground below the focal point of the parabolic dish 12 and the carrier tube 16 is in the form of a fiber optic carrying tube or cable. This third embodiment of the thermal transpiration generator system 10b illustrates that the thermal transpiration generator 18 can alternatively be located in any other suitable location and/or the thermal transpiration generator system 10 can alternatively have other suitable configurations.

FIG. 14 shows a thermal transpiration generator system 10c according to a fourth embodiment of the present invention. This thermal transpiration generator system 10c is substantially the same as the thermal transpiration generator system 10b described above according to the third embodiment of the present invention except that the thermal transpiration generator 18 has fewer sets of vanes 28 and the flywheel 42 is located outside the sealed vacuum container 20. This fourth embodiment of the thermal transpiration generator system 10c illustrates that the thermal transpiration generator 18 can alternatively have other suitable configurations.

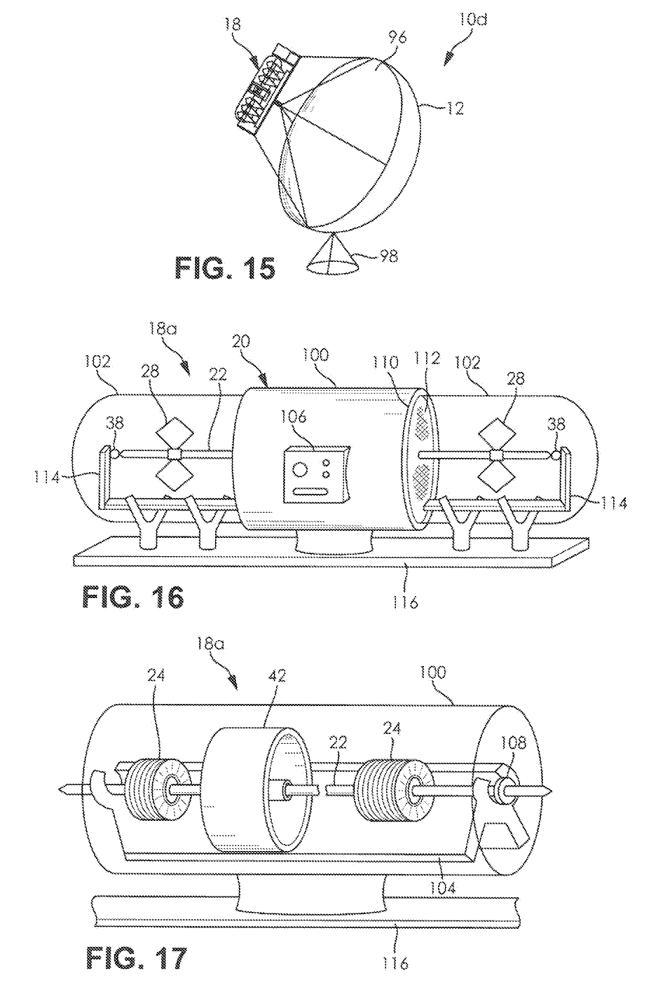

FIG. 15 shows a thermal transpiration generator system 10d according to a fifth embodiment of the present invention. This thermal transpiration generator system 10d is substantially the same as the thermal transpiration generator system 10b described above according to the third embodiment of the present invention except that the thermal transpiration generator 18 is secured to the front of the parabolic dish 12 near the focal point of the parabolic dish 12 and directly receives the solar energy from the reflective surface 96 of the parabolic dish 12. This fifth embodiment of the thermal transpiration generator system 10d illustrates that the thermal transpiration generator 18 can alternatively have other suitable locations.

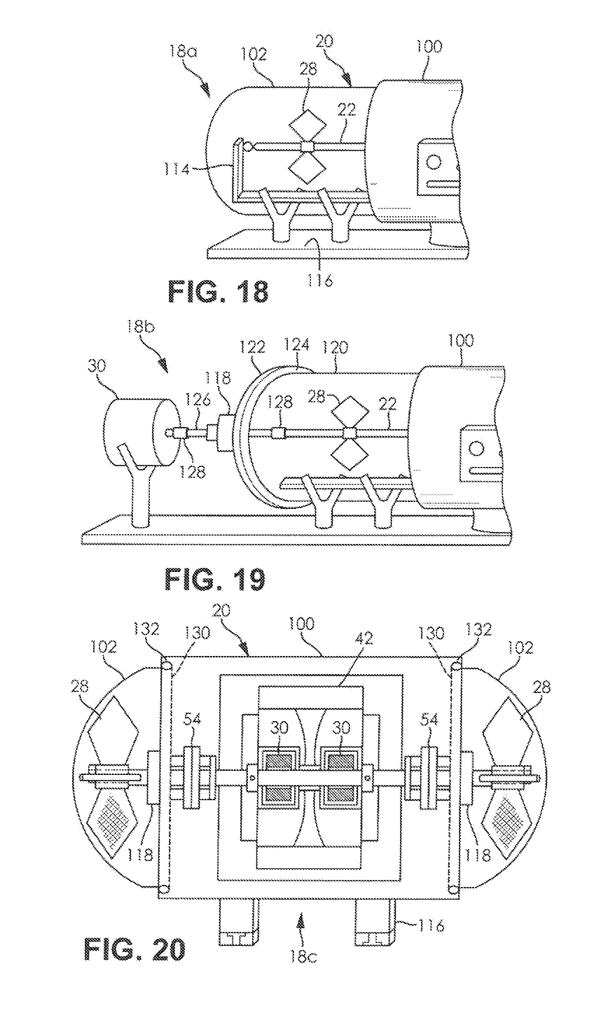

FIGS. 16 to 18 shows a thermal transpiration device or generator 18a according to a sixth embodiment of the present invention. This thermal transpiration generator 18a is substantially the same as the thermal transpiration generator 18 described above according to the first embodiment of the present invention except that the vacuum container 20 of the thermal transpiration generator 18a has a central cylinder or body 100 housing the flywheel 42 and the electric generator 30 and opposed bell jars 102 housing the sets of vanes 28a, 28b, 28c, 28d, 28e, 28f. This sixth embodiment illustrates that the thermal transpiration generator 18 can alternatively have other suitable configurations.

The illustrated vacuum container 20 has a bell jar design that includes the central body 100 and the bell jars 102 extending in opposite directions from the ends of the central body 100. The illustrated central body 100 is in the form of a cylinder and houses a mounting fixture 104, a vacuum feed through and controls 106, an RPM (Revolution Per Minute) counter 108, the passive frictionless magnetic bearings 24, the flywheel 42, the alternator or electric generator (not shown), and a vacuum seal 110 to seal the bell jars 102 to central body 100. The shaft 22 extends the length of the vacuum container 20 with the vanes 28 located within the bell jars 102. The transparent globes of the bell jars 102 permit sunlight to enter the vacuum container 20 to engage the vanes 20. Steel mesh 112 is provided to separate the central housing 100 from the bell jars 102. Jeweled bearings 38 are located the ends of the shaft 22 which are held by bearing supports 114. A base support or support stand 116 (which may include gimbal adjustments) is secured to the cylindrical body 100 and includes supports for the bell jars 102.

FIG. 19 shows a variation of the thermal transpiration device or generator 18b according to the sixth embodiment of the present invention. The thermal transpiration device or generator 18b is substantially the same as the second embodiment of the invention shown in FIGS. 16 to 18 except that the electric generator 30 is located outside the sealed vacuum container 20, the shaft 22 passes through the wall 46 of the vacuum container 20 through a vacuum feed through 118 which supports the shaft 22 in place of the jewel bearing 38 and its support 114.

The bell jar 102 is modified so that the shaft 22 extends through the end of the bell jar 102 to the electric generator 30 located outside the vacuum container 20. The illustrated bell jar 102 includes a glass cylinder 120 and a metallic end plate 122 closing the open end of the glass cylinder 120. A suitable gasket 124 is provided to seal the glass cylinder 120 to the metallic end plate 122. A shaft extension 126 extends from the shaft 22 to the electric generator 30 through the rotary shaft vacuum feed through device 118 in the end plate 122. The shaft extension 126 is secured to the shaft 22 and the electric generator 30 with mechanical shaft couplings 128. It is noted that the jewel bearing 38 and its support 114 are eliminated on the electric generator end of the shaft 22.

FIG. 20 shows a thermal transpiration device or generator 18c according to a seventh embodiment of the present invention. This thermal transpiration generator 18c is substantially the same as the thermal transpiration generator 18a described above according to the sixth embodiment of the present invention except that the central body 100 is not under vacuum and the opposed bell jars 102 are under vacuum. This seventh embodiment further illustrates that the thermal transpiration generator 18 can alternatively have other suitable configurations.

Ends of the central body 100 are provided with metallic separating plates 130 and suitable gaskets or other seals 132 so that that only the bell jars 102 contain a vacuum. Rotary shaft vacuum feed through devices 118 are provided at the plates 130 for passage of the shaft 22 therethrough to maintain the seal of the bell jars 102. It is noted that two of the electric generators 30 are located within the flywheel 42.

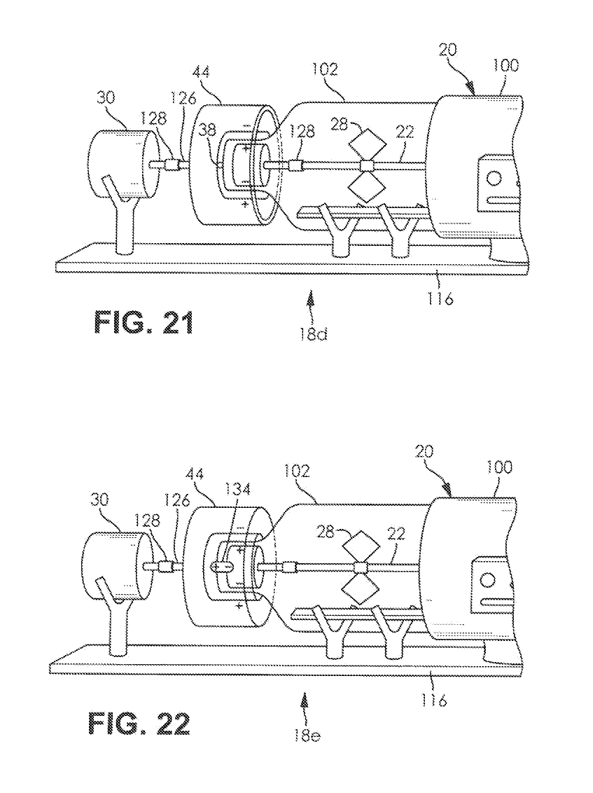

FIG. 21 shows a thermal transpiration device or generator 18d according to an eighth embodiment of the present invention. This thermal transpiration generator 18d is substantially the same as the thermal transpiration generator 18b described above according to the sixth embodiment of the present invention except that the electric generator 30 is located outside the sealed vacuum container 20 and is operatively coupled to the shaft 22 with a magnetic coupling 44. This eighth embodiment further illustrates that the thermal transpiration generator 18 can alternatively have other suitable configurations.

FIG. 22 shows a thermal transpiration device or generator 18e according to a ninth embodiment of the present invention. This thermal transpiration generator 18e is substantially the same as the thermal transpiration generator 18d described above according to the eighth embodiment of the present invention except that a jewel bearing 38 within the magnetic coupling 44 is replaced with a pair of opposing magnets 134. This ninth embodiment further illustrates that the thermal transpiration generator 18 can alternatively have other suitable configurations.

Any of the features or attributes of the above described embodiments and variations can be used in combination with any of the other features and attributes of the above described embodiments and variations as desired.

The illustrated systems according to the present invention may be used to power a home, charge car batteries, act as a power source during power outages, provide power to electric companies, provide power at remote locations where power lines currently don't exist, power cell towers, and road signs. The illustrated systems can be taken to outer space and power a remote work station located in space or on another planetary body (moon, mars, etc.) and may be used for colonizing people to those worlds.

It is apparent from the above detailed description of preferred embodiments of the present invention, that the thermal transpiration generator systems according to the present invention may provide the cheapest, cleanest, free energy available to mankind. The present invention may utilize the sun's energy and turn mechanical energy into power output and may require much less space than what solar panels currently require and at a much less overall cost. The present invention may utilize the sun to generate its power and in-turn this power is utilized in generating auxiliary power for multiple uses. More homes may utilize the present invention compared to solar panels due to the space constraints. The present invention may utilize the free energy of the sun to generate power versus some of the gas powered back-up generators. This generator may be less expensive to manufacture than solar panels (amount of power versus overall cost). The design of this generator may outlast (life of product) over other power sources currently available.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A thermal transpiration generator comprising, in combination:
a sealed container;
a rotatable shaft horizontally disposed within the sealed container;
bearings supporting the rotatable shaft within the sealed container;
a first set of at least two vanes secured to the rotatable shaft for rotation therewith;
a second set of at least two vanes secured to the rotatable shaft for rotation therewith and spaced apart from the first set of at least two vanes along the length of the rotatable shaft;
wherein each of the vanes has a light reflecting side and an opposite light absorbing side;
an electric generator operatively coupled to the rotatable shaft to be driven by rotation of the rotatable shaft; and
a solar energy distribution system for directing light to each of the first and second sets of at least two vanes.

2. The thermal transpiration generator according to claim 1, further comprising a high RPM flywheel secured to the rotatable shaft for rotation therewith.

3. The thermal transpiration generator according to claim 2, wherein the flywheel is located along the length of the shaft between the first and second sets of at least two vanes.

4. The thermal transpiration generator according to claim 2, wherein the flywheel comprises graphene.

5. The thermal transpiration generator according to claim 1, wherein the electric generator is located outside the sealed container and is coupled to the rotatable shaft with a magnetic coupler.

6. The thermal transpiration generator according to claim 1, wherein the electric generator is a low torque and high RPM generator.

7. The thermal transpiration generator according to claim 1, wherein the sealed container is hermetically sealed and wherein no electric al components are located within the sealed container.

8. The thermal transpiration generator according to claim 1, further comprising a cooling jacket located about the sealed container and the electric generator.

9. The thermal transpiration generator according to claim 1, wherein the bearings are passive magnetic bearings.

10. A thermal transpiration generator comprising, in combination:
a sealed container;
a rotatable shaft disposed within the sealed container;
bearings supporting the rotatable shaft within the sealed container;
a first set of at least two vanes secured to the rotatable shaft for rotation therewith;
a second set of at least two vanes secured to the rotatable shaft for rotation therewith and spaced apart from the first set of at least two vanes along the length of the rotatable shaft;
wherein each of the vanes has a light reflecting side and an opposite light absorbing side;
a high RPM flywheel secured to the rotatable shaft for rotation therewith;
an electric generator operatively coupled to the rotatable shaft to be driven by rotation of the rotatable shaft; and
a solar energy distribution system for directing light to each of the first and second sets of at least two vanes.

11. The thermal transpiration generator according to claim 10, wherein the flywheel is located along the length of the shaft between the first and second sets of at least two vanes.

12. The thermal transpiration generator according to claim 10, wherein the flywheel comprises graphene.

13. The thermal transpiration generator according to claim 10, wherein the electric generator is located outside the sealed container and is coupled to the rotatable shaft with a magnetic coupler.

14. The thermal transpiration generator according to claim 10, wherein the electric generator is a low torque and high RPM generator.

15. The thermal transpiration generator according to claim 10, wherein the sealed container is hermetically sealed and wherein no electric al components are located within the sealed container.

16. The thermal transpiration generator according to claim 10, further comprising a cooling jacket located about the sealed container and the electric generator.

17. The thermal transpiration generator according to claim 10, wherein the bearings are passive magnetic bearings.

18. A thermal transpiration generator system comprising, in combination:
a parabolic dish;
a secondary reflector receiving solar energy from the parabolic dish;
a carrier tube receiving solar energy from the secondary reflector; and
a thermal transpiration generator including:
a sealed container;
a rotatable shaft disposed within the sealed container;
bearings supporting the rotatable shaft within the sealed container;
a first set of at least two vanes secured to the rotatable shaft for rotation therewith;
a second set of at least two vanes secured to the rotatable shaft for rotation therewith and spaced apart from the first set of at least two vanes along the length of the rotatable shaft;
wherein each of the vanes has a light reflecting side and an opposite light absorbing side;
an electric generator operatively coupled to the rotatable shaft to be driven by rotation of the rotatable shaft; and
a solar energy distribution system for receiving solar energy from the carrier tube and directing light to each of the first and second sets of at least two vanes.

19. The thermal transpiration generator system according to claim 18, wherein the rotatable shaft of the thermal transpiration generator is horizontally disposed.

20. The thermal transpiration generator system according to claim 18, wherein thermal transpiration generator further includes a high RPM flywheel secured to the rotatable shaft for rotation therewith.
